(19) United States
(12) Patent Application Publication
(10) Pub. No.: US 2014/0238987 A1
(43) Pub. Date: Aug. 28, 2014

(54) FOLDABLE SPOON AND METHOD FOR MAKING

(71) Applicant: Matthew Brooks, Santa Cruz, CA (US)

(72) Inventor: Matthew Brooks, Santa Cruz, CA (US)

(21) Appl. No.: 13/779,426

(22) Filed: Feb. 27, 2013

(51) Int. Cl. B65D 51/24; B31D 5/04; A47G 21/04

(52) U.S. Cl. CPC B65D 51/246; A47G 21/04; B31D 5/04
USPC 220/212; 30/324; 493/405

(57) ABSTRACT

A foldable spoon. A spoon handle includes apex folds and valley folds that are used to create a strong spoon handle. A spoon cup section is connected to the spoon handle. The spoon apex folds, spoon valley folds and spoon cup section are preferably formed from a single sheet of foldable material.

The present invention relates to eating utensils, and in particular, to folding spoons. This application is a Continuation-in-Part (CIP) of U.S. patent application Ser. No. 13/401,673 filed Feb. 21, 2012, which claims the benefit of Provisional Application 61/444,745, filed on Feb. 20, 2011, both of which are incorporated by reference herein.

### BACKGROUND OF THE INVENTION

### Paper

Paper is a thin material mainly used for writing upon, printing upon or for packaging. It is produced by pressing together moist fibers, typically cellulose pulp derived from wood, rags or grasses, and drying them into flexible sheets.

### Cardboard

Cardboard is a generic term for a heavy-duty paper. It may refer to: binder's board, card stock (heavy paper used for making cards), corrugated fiberboard (a combination of paperboards, usually two flat liners and one inner fluted corrugated medium, often used for making corrugated boxes), display board, poster board, paperboard, (a paper-based material often used for folding cartons, set-up boxes, carded packaging, etc.), containerboard, folding boxboard, solid bleached board, solid unbleached board, or white lined chipboard.

### Paperboard

Paperboard is a thick paper based material. While there is no rigid differentiation between paper and paperboard, paperboard is generally thicker (usually over 0.25 mm/0.010 in or 10 points) than paper. According to ISO standards, paperboard is a paper with a basis weight (grammage) above 224 g/m², but there are exceptions. Paperboard can be single or multi-ply. Paperboard used for the manufacture of folding cartons and rigid set-up boxes is often called boxboard. Paperboards used for the manufacture of corrugated fiberboard are called containerboard. It can be easily cut and formed, is lightweight, and because it's strong, it's used in packaging. Another end-use would be graphic printing, such as book and magazine covers or postcards. Sometimes it is referred to as cardboard, which is a generic, lay term used to refer to any heavy paper pulp based board.

Within the packaging industry, the generic term is more often pasteboard, and specific kinds are referred to by their initials or a shorthand. The most common types used for retail packaging are SB (solid bleach), CCKB (clay-coated kraft back) and CCNB (clay-coated news back).

### Card Stock

Card stock, also called cover stock or pasteboard, is a paper stock that is thicker and more durable than normal writing or printing paper, but thinner and more flexible than other forms of paperboard. Card stock is often used for business cards, postcards, playing cards, catalog covers, scrapbooking, and other uses which require higher durability than regular paper. The texture is usually smooth, but can be textured, metallic, or glossy.

Card stock thickness is often described by pound weight. Pound weight is the weight of 500 sheets of 20 by 26 in (508 by 660 mm) paper. This differs from how text stock is determined, which assumes 500 sheets of 25 by 38 in (635 by 965 mm) paper. Most countries use the term grammage to describe the weight of the paper in grams per square meter. The term card stock is used to describe paper with weights from 50 lb to 110 lb (about 135 to 300 g/m²).

In the U.S., card stock thickness is usually measured in points or mils that gives the thickness of the sheet in thousandths of an inch. For example, a 10 pt. card is 0.010 in (0.254 mm) thick (roughly corresponding to a weight of 250 g/m²); 12 pt. is 0.012 in (0.3048 mm).

### Origami

Origami from ori meaning “folding”, and kami meaning “paper”) is the traditional Japanese folk art of paper folding, which started in the 17th century AD and was popularized in the mid-1900s. It has since then evolved into a modern art form. The goal of this art is to transform a flat sheet of material into a finished sculpture through folding and sculpting techniques, and as such the use of cuts or glue are not considered to be origami.

### Disposable Spoons

Currently a consumer may purchase a disposable spoon. Common disposable spoons are plastic spoons ideal for picnics and very casual eating affairs. However, the prior art spoons are not ideal for all situations.

What is needed is a better folding spoon.

### SUMMARY OF THE INVENTION

The present invention provides a foldable spoon. A spoon handle includes apex folds and valley folds that are used to create a strong spoon handle. A spoon cup section is connected to the spoon handle. The spoon apex folds, spoon valley folds and spoon cup section are preferably formed from a single sheet of foldable material.

### BRIEF DESCRIPTION OF THE PREFERRED EMBODIMENTS

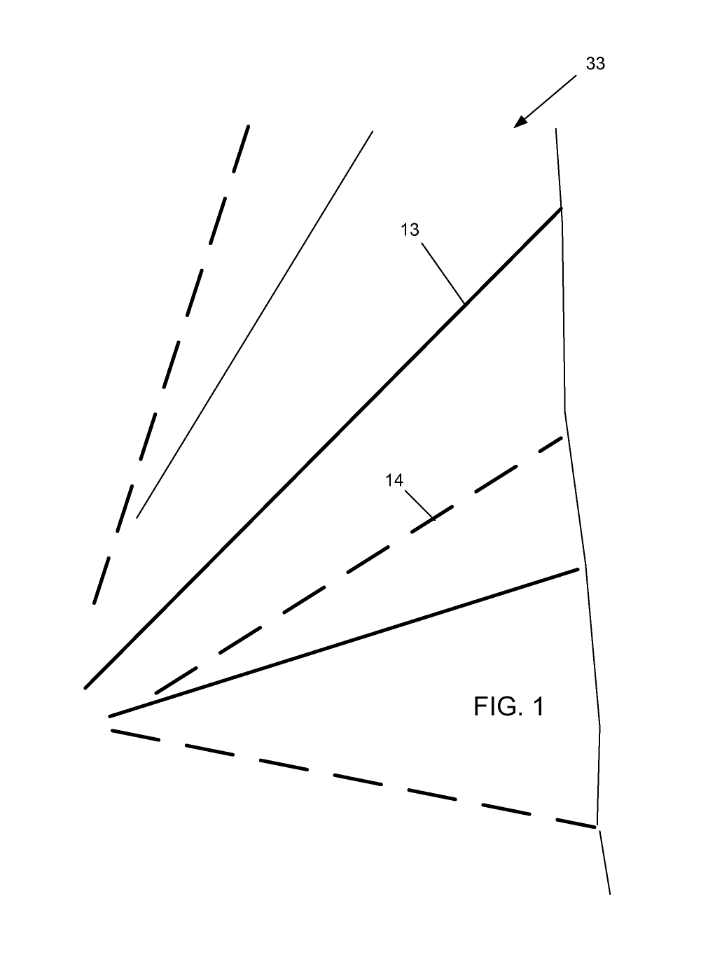

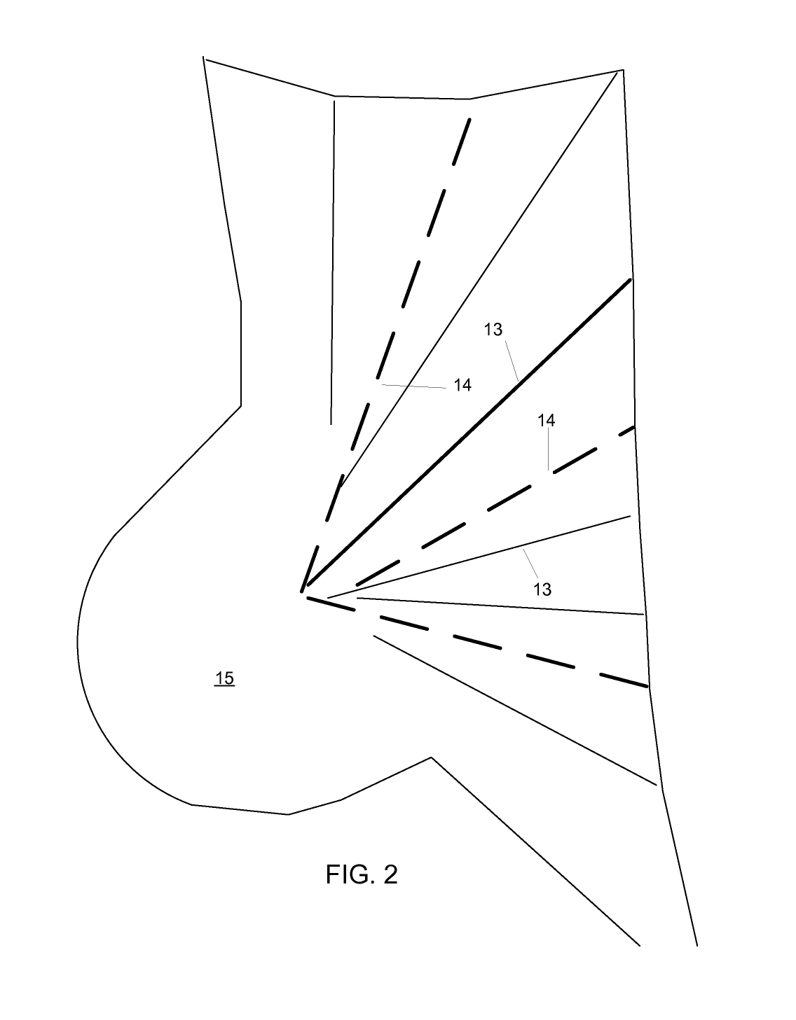

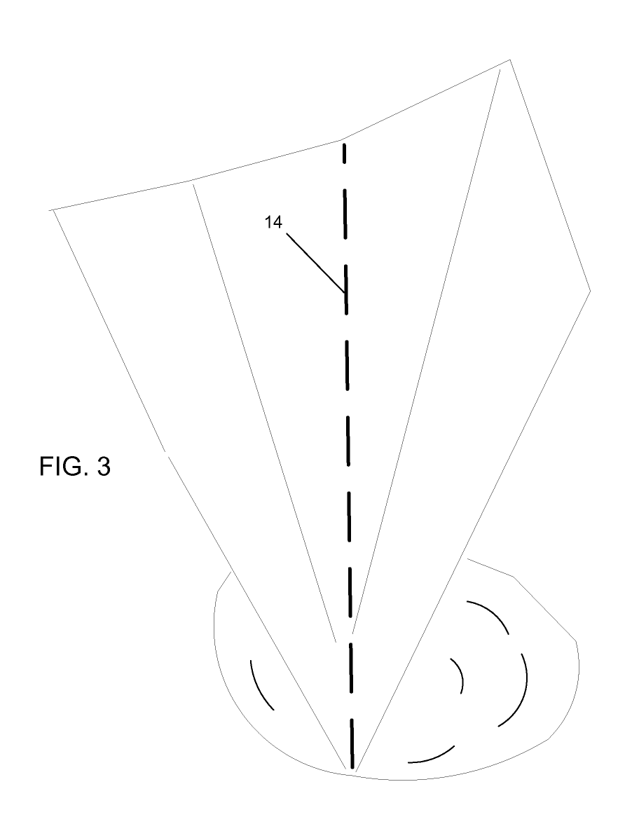

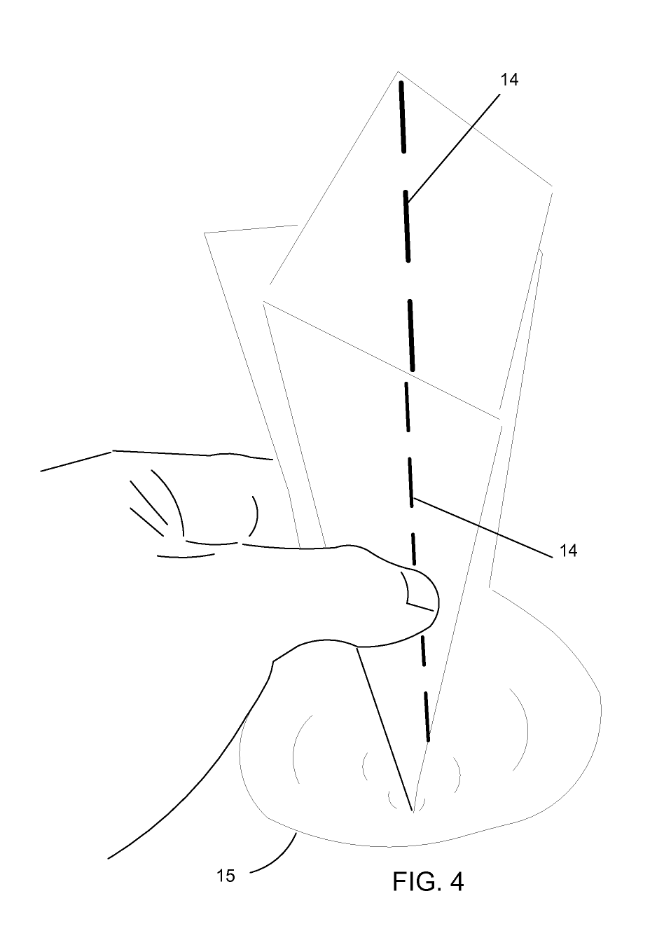

FIGS. 1-6 show a preferred embodiment of the present invention.

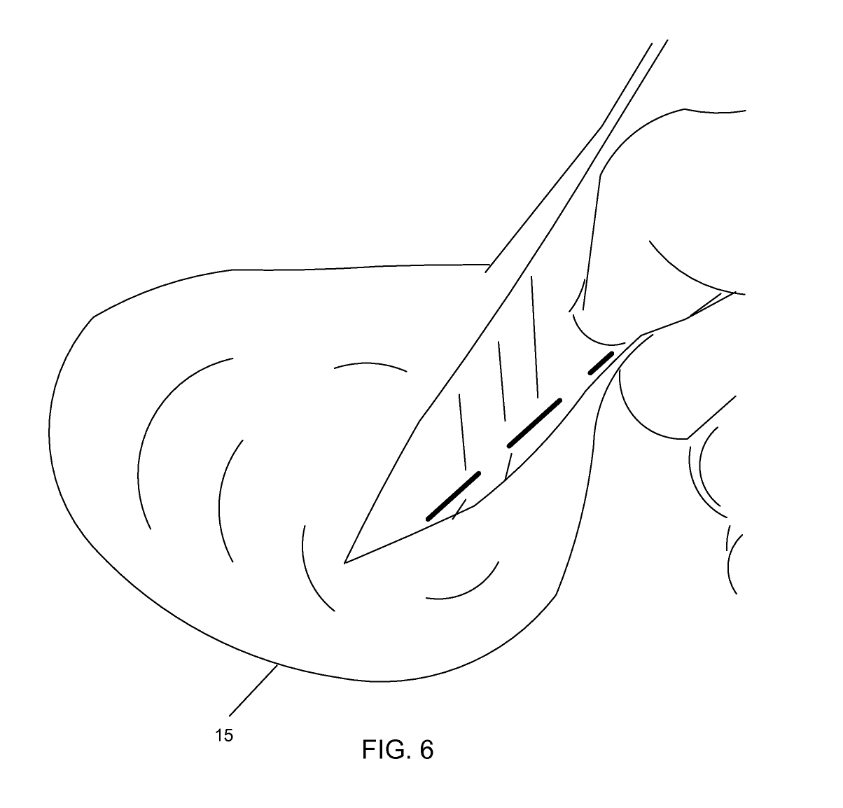

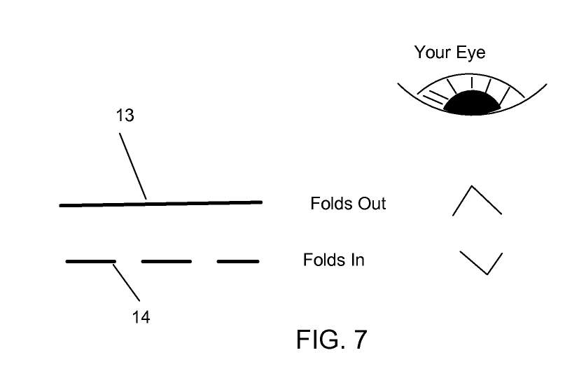

FIG. 7 shows a preferred key.

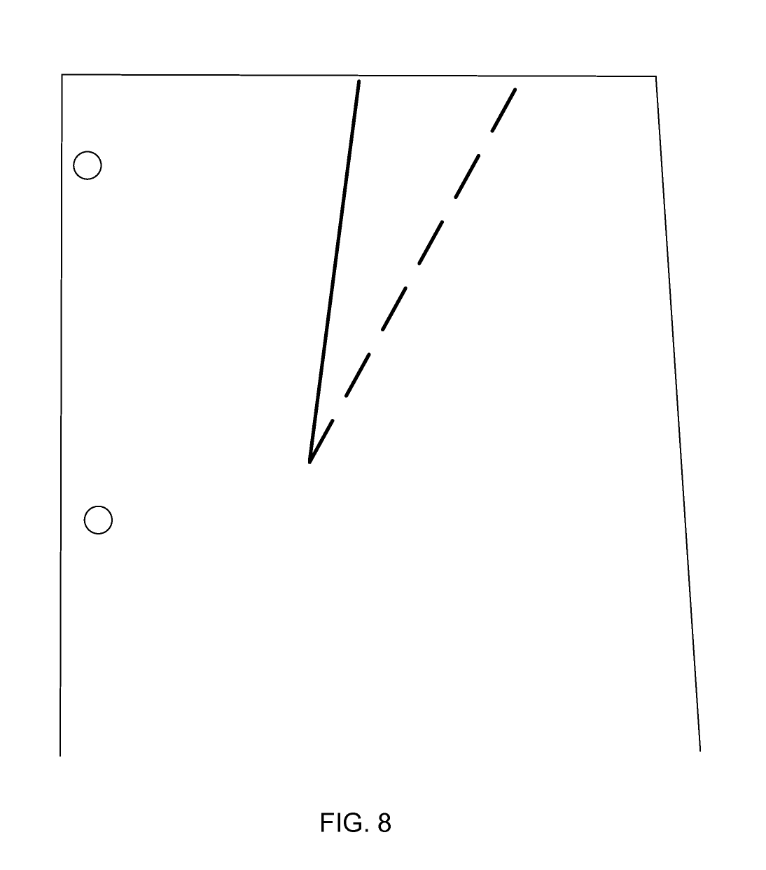

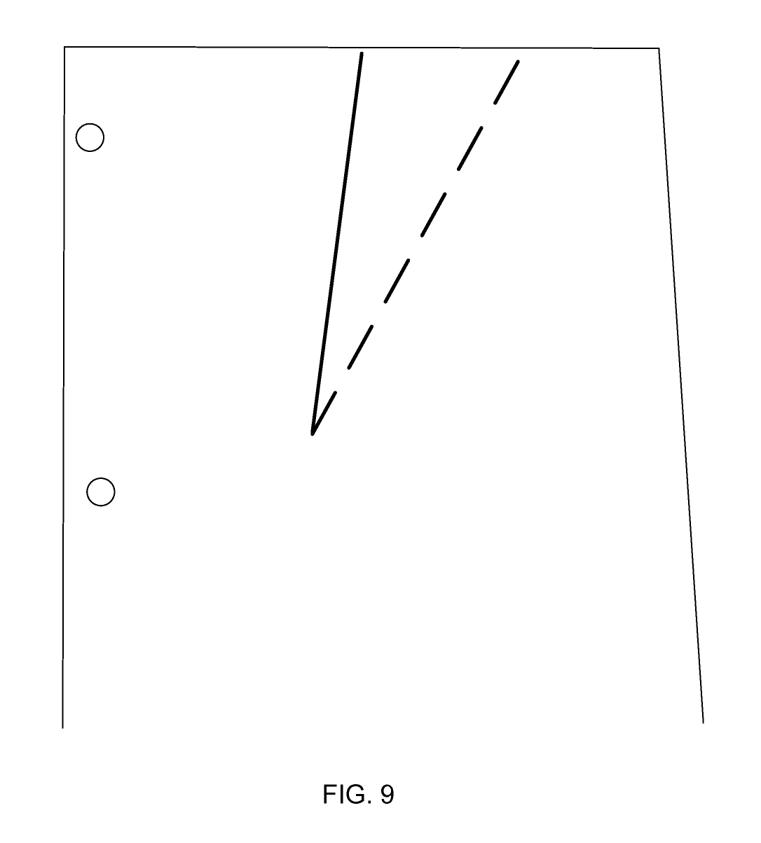

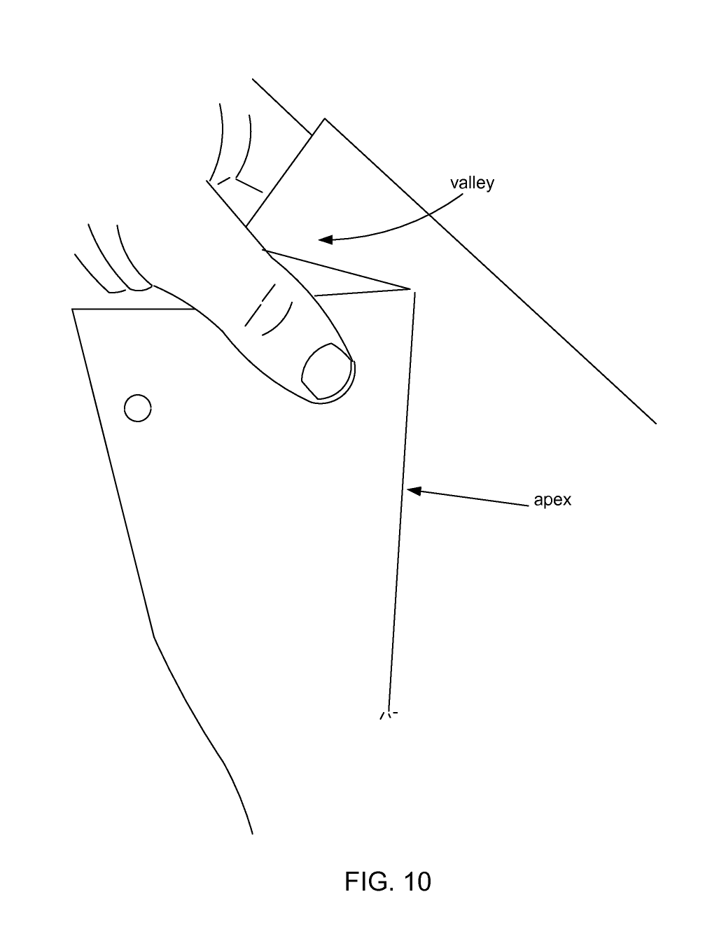

FIGS. 8-10 show another preferred embodiment of the present invention.

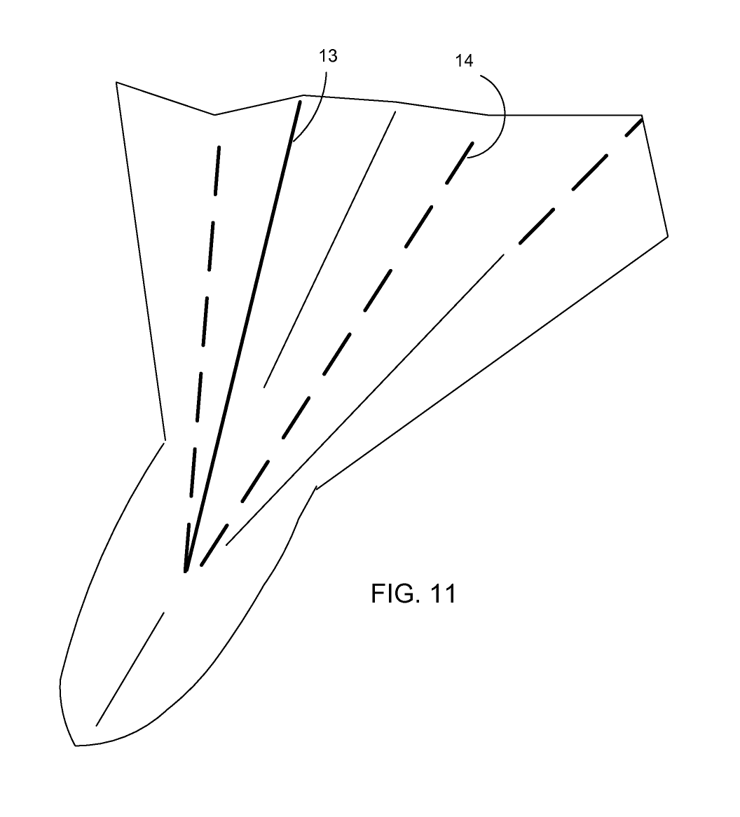

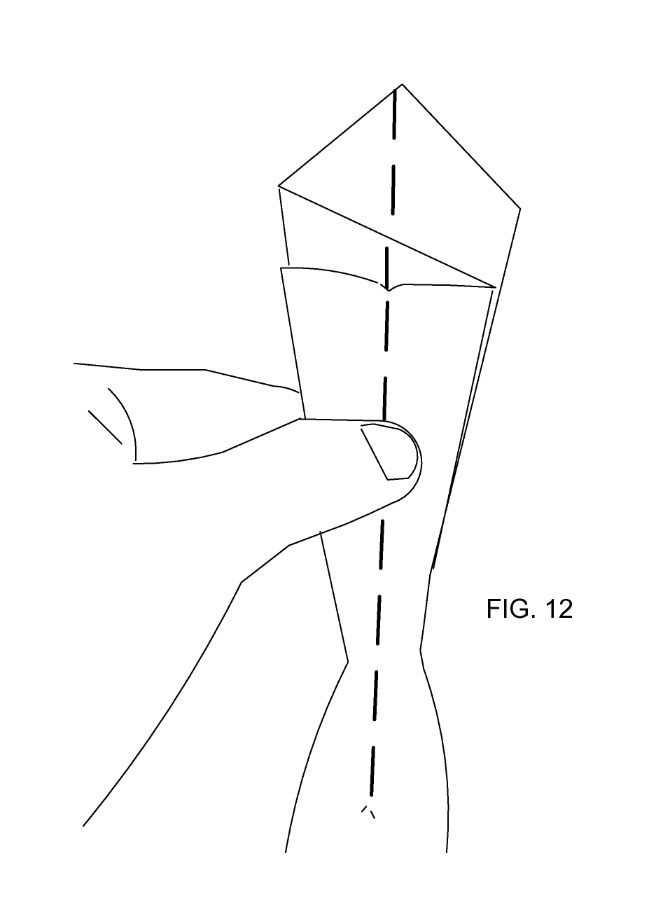

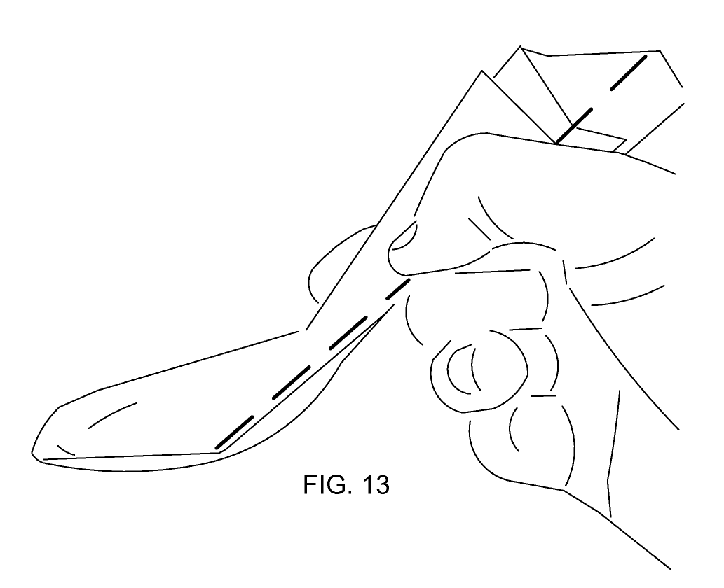

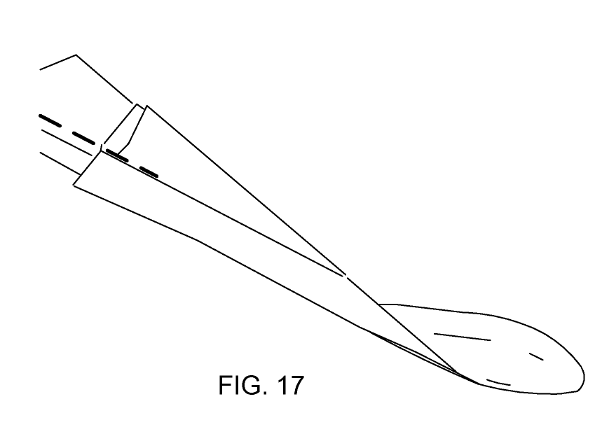

FIGS. 11-18 show another preferred embodiment of the present invention.

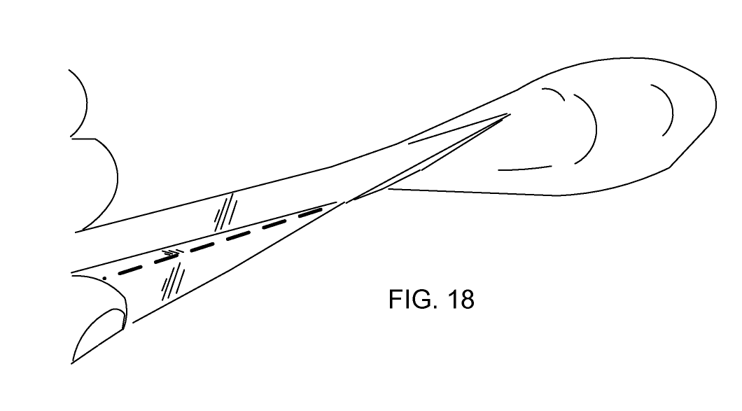

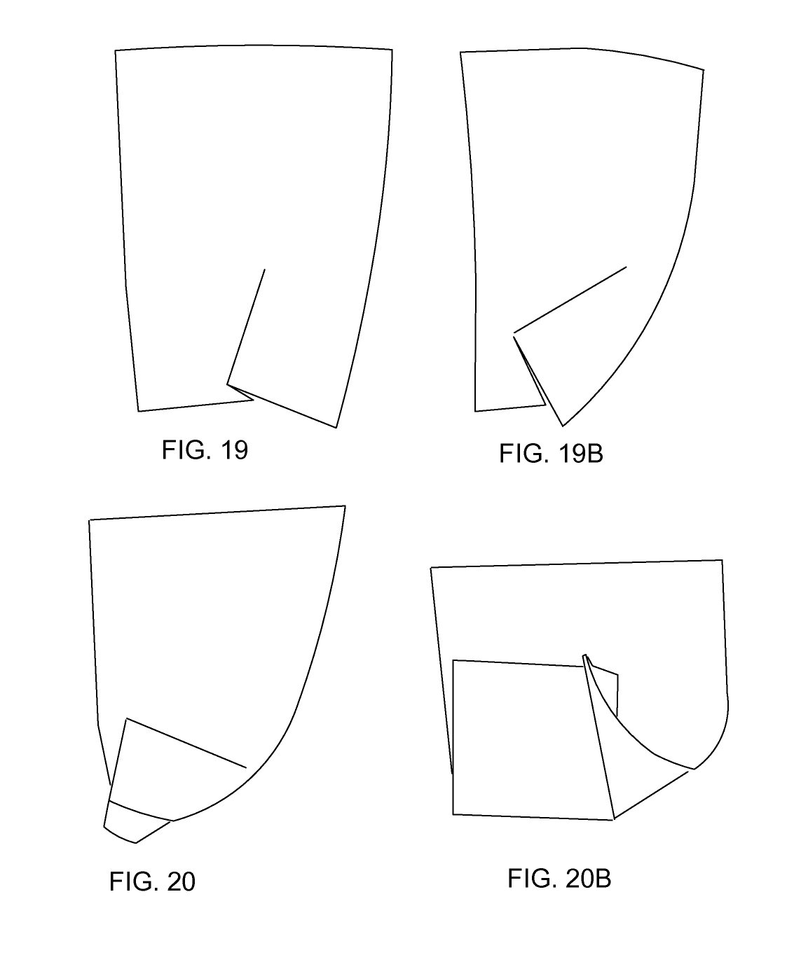

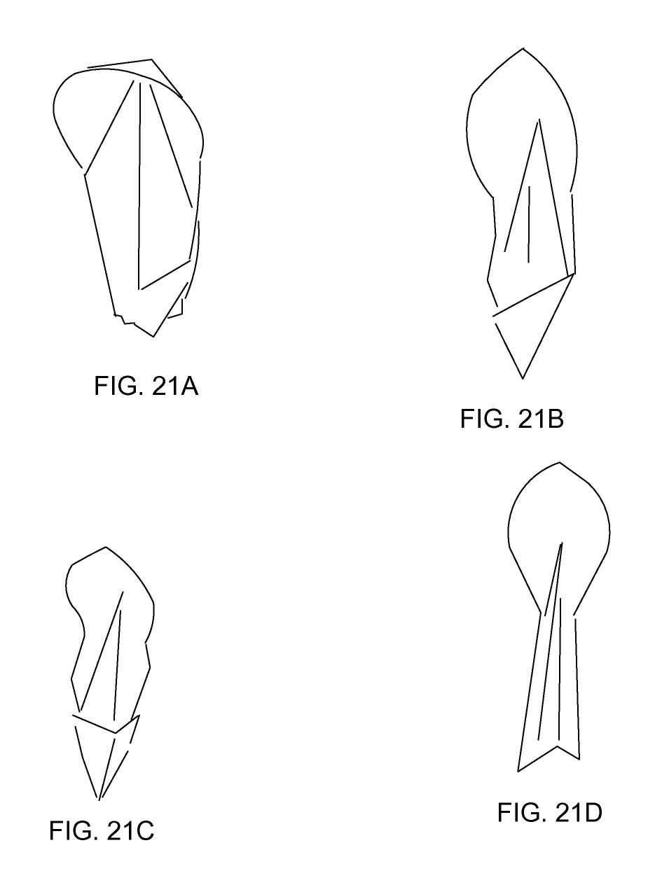

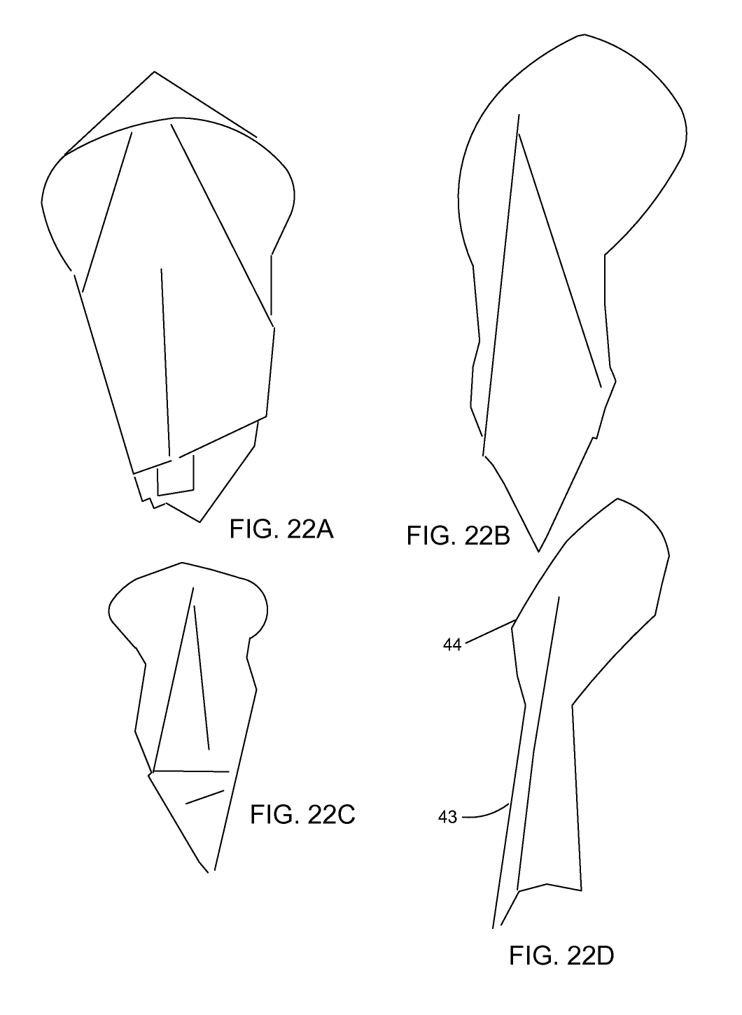

FIGS. 19-22 show another preferred embodiment of the present invention.

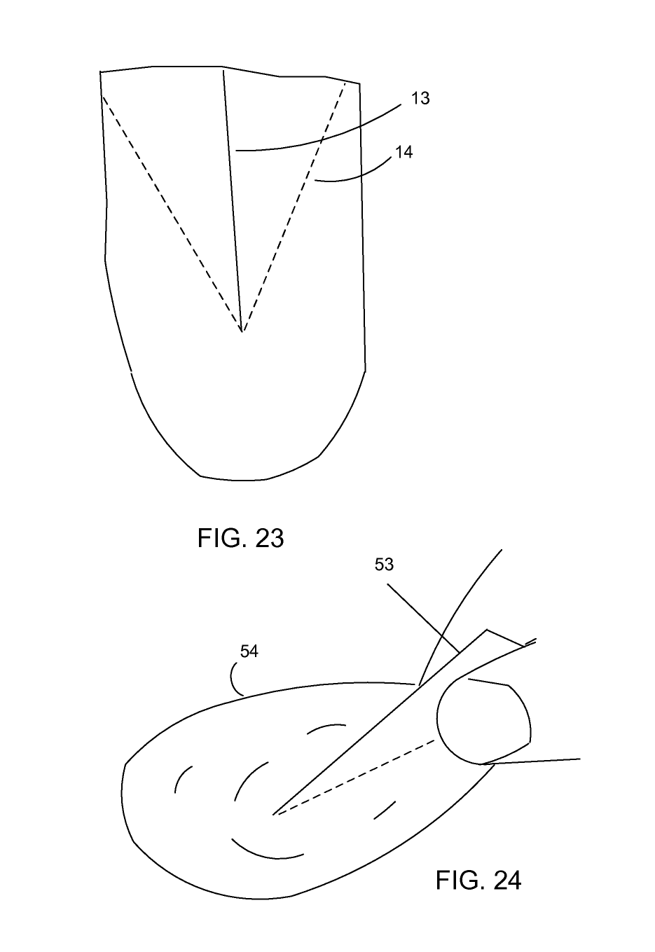

FIGS. 23-24 show another preferred embodiment of the present invention.

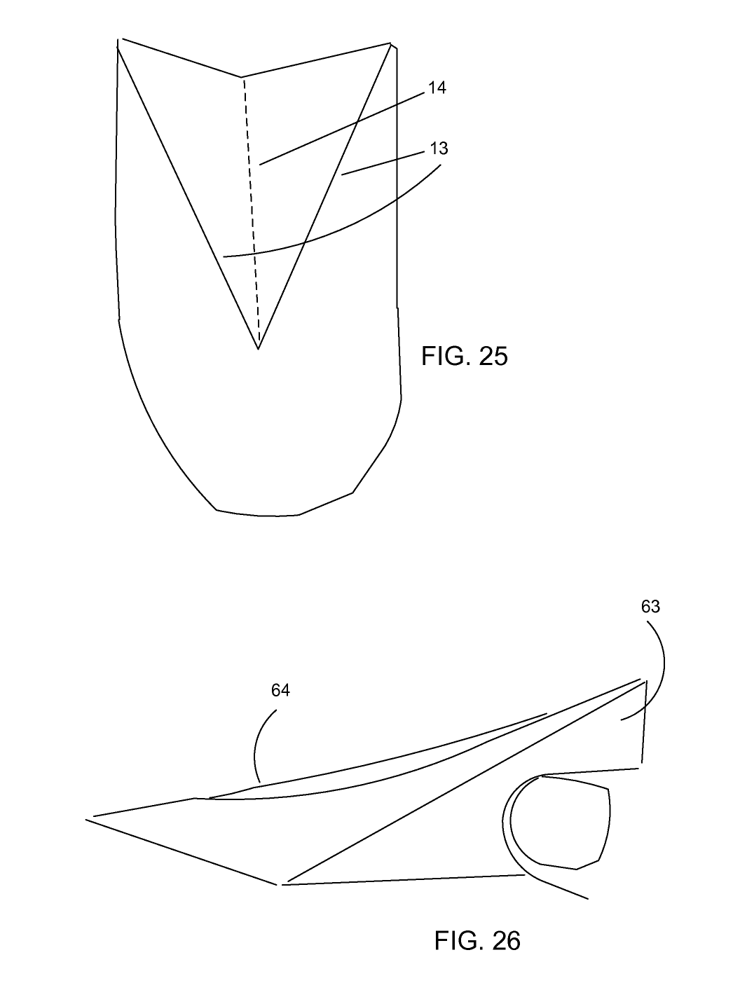

FIGS. 25-26 show another preferred embodiment of the present invention.

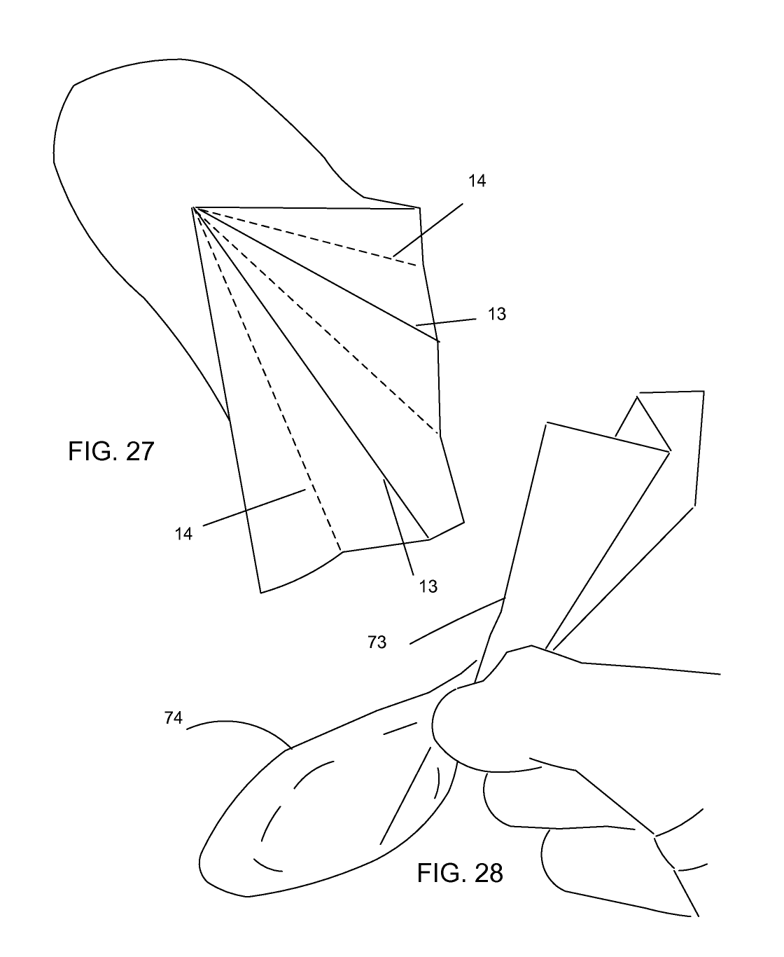

FIGS. 27-28 show another preferred embodiment of the present invention.

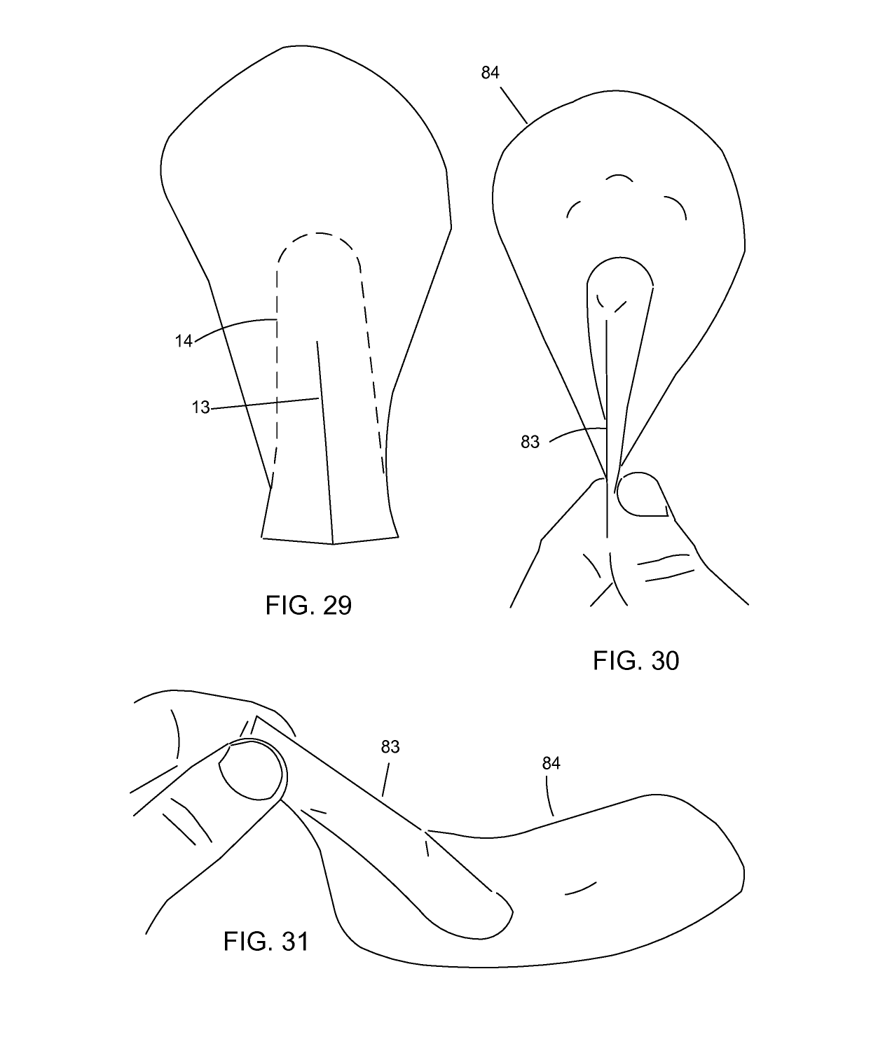

FIGS. 29-31 show another preferred embodiment of the present invention.

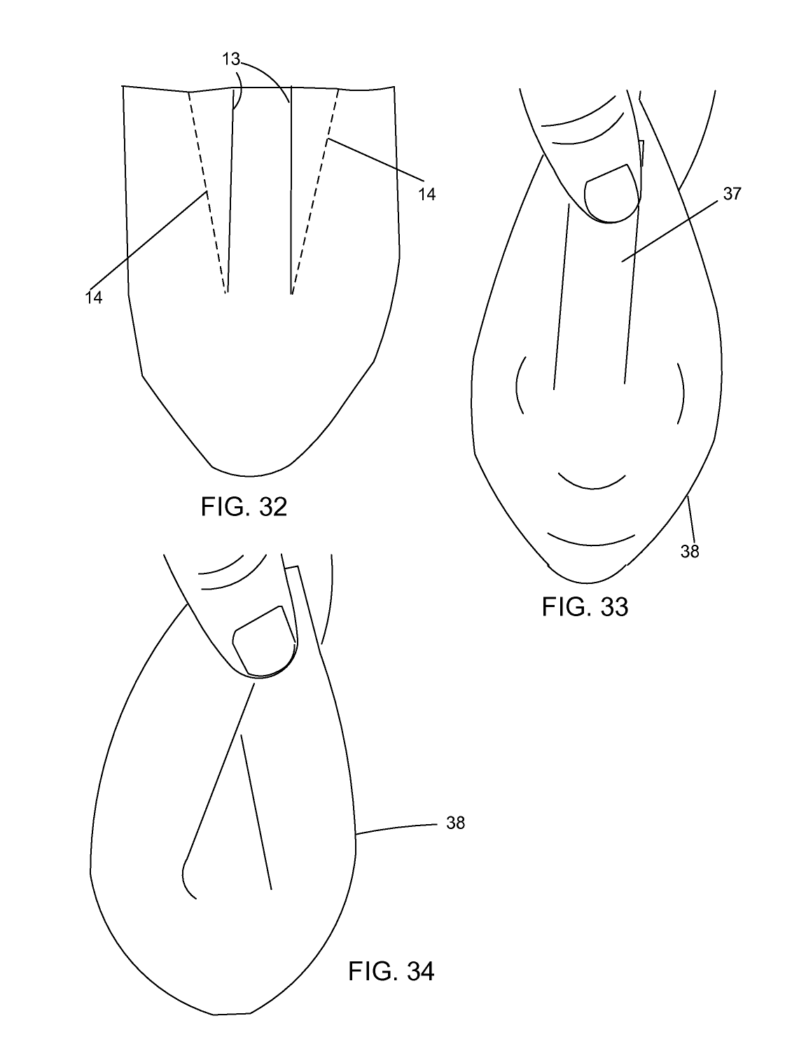

FIGS. 32-34 show another preferred embodiment of the present invention.

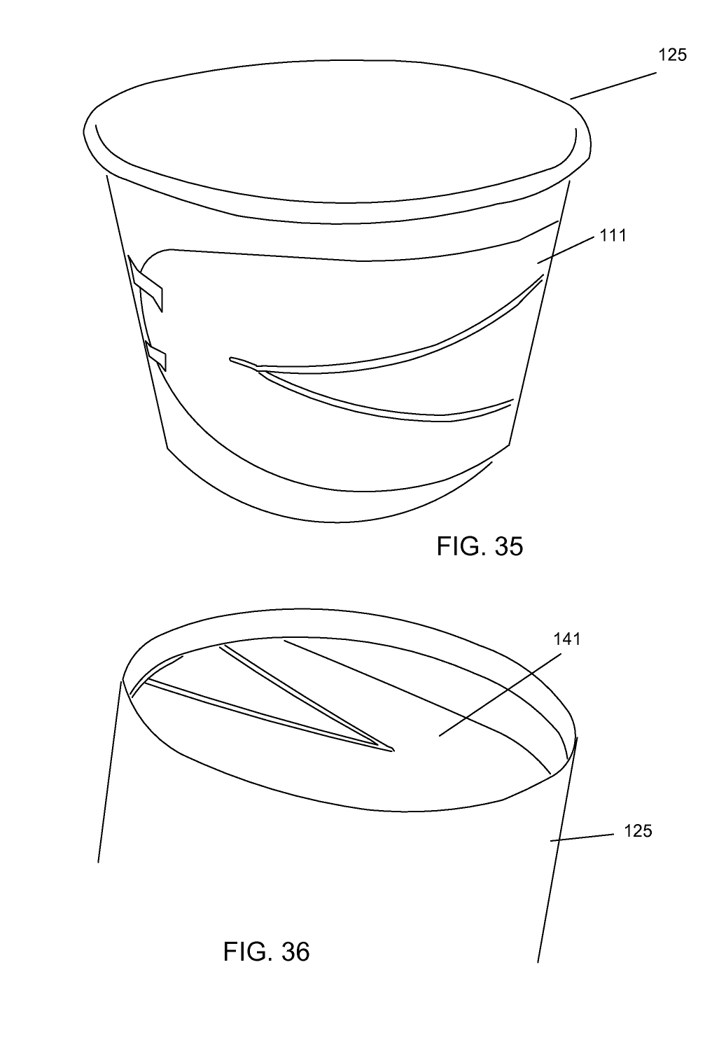

FIGS. 35-37 show alternate methods for attaching a preferred unfolded spoon to a preferred ice cream container.

FIG. 38 shows another preferred embodiment of the present invention.

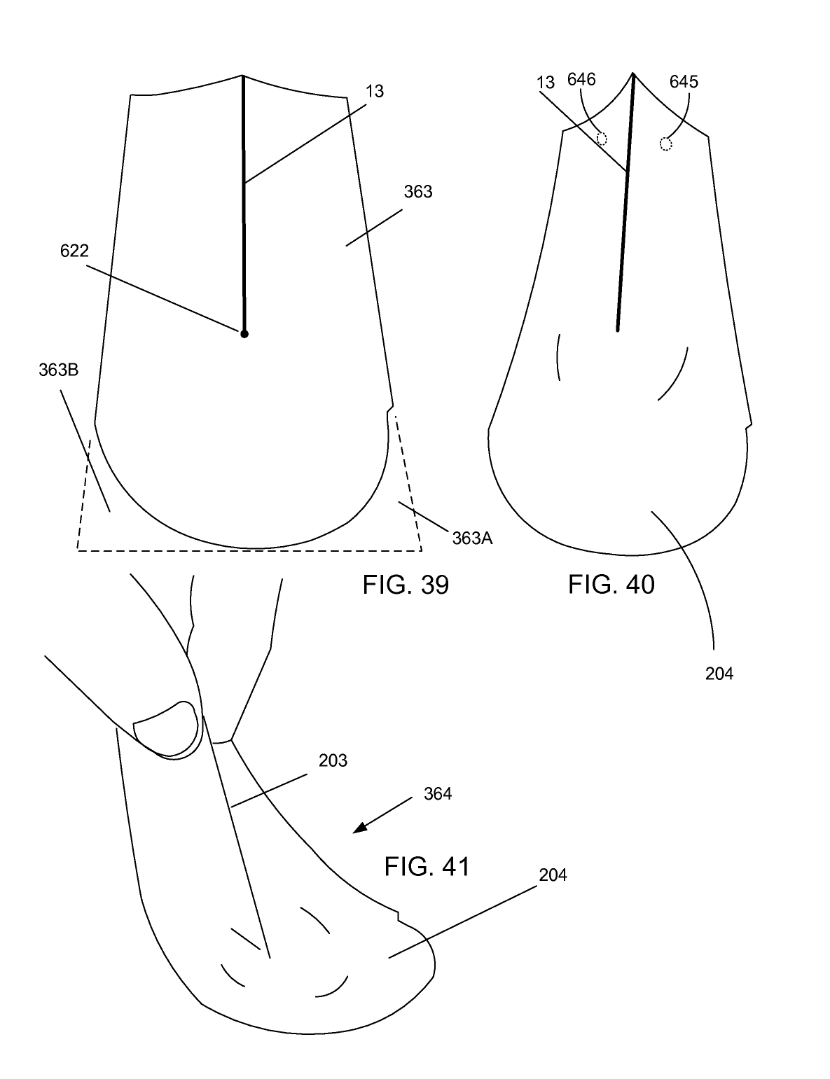

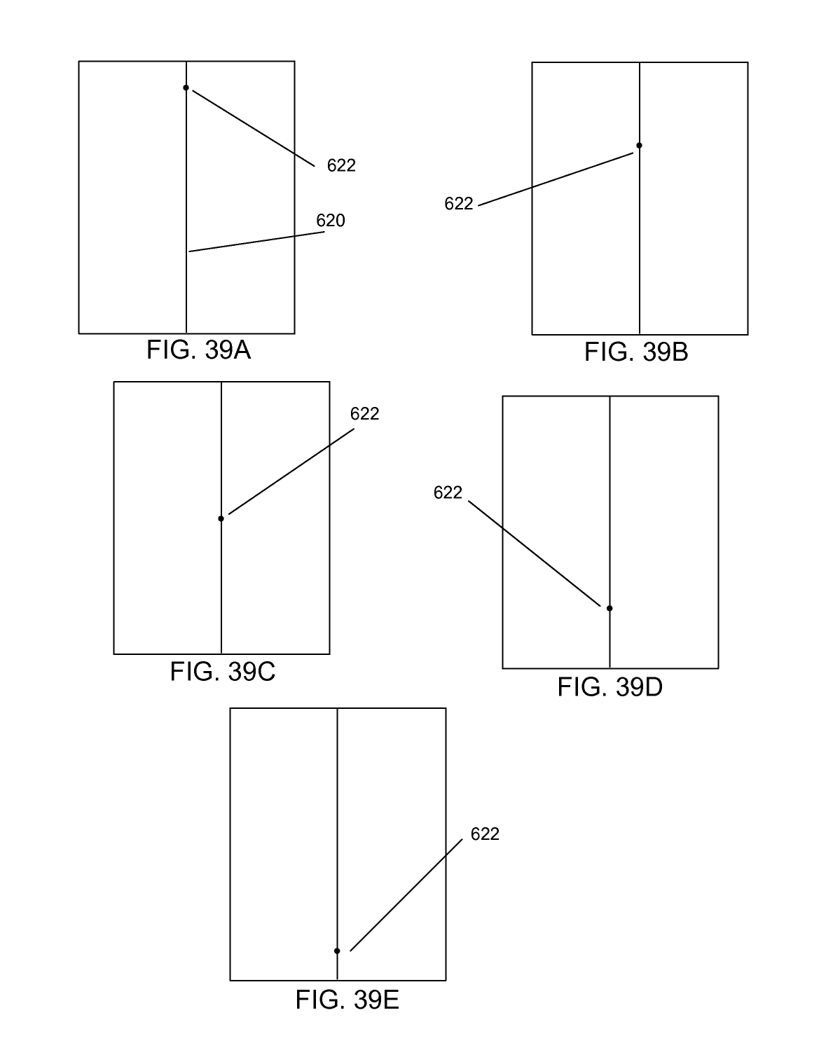

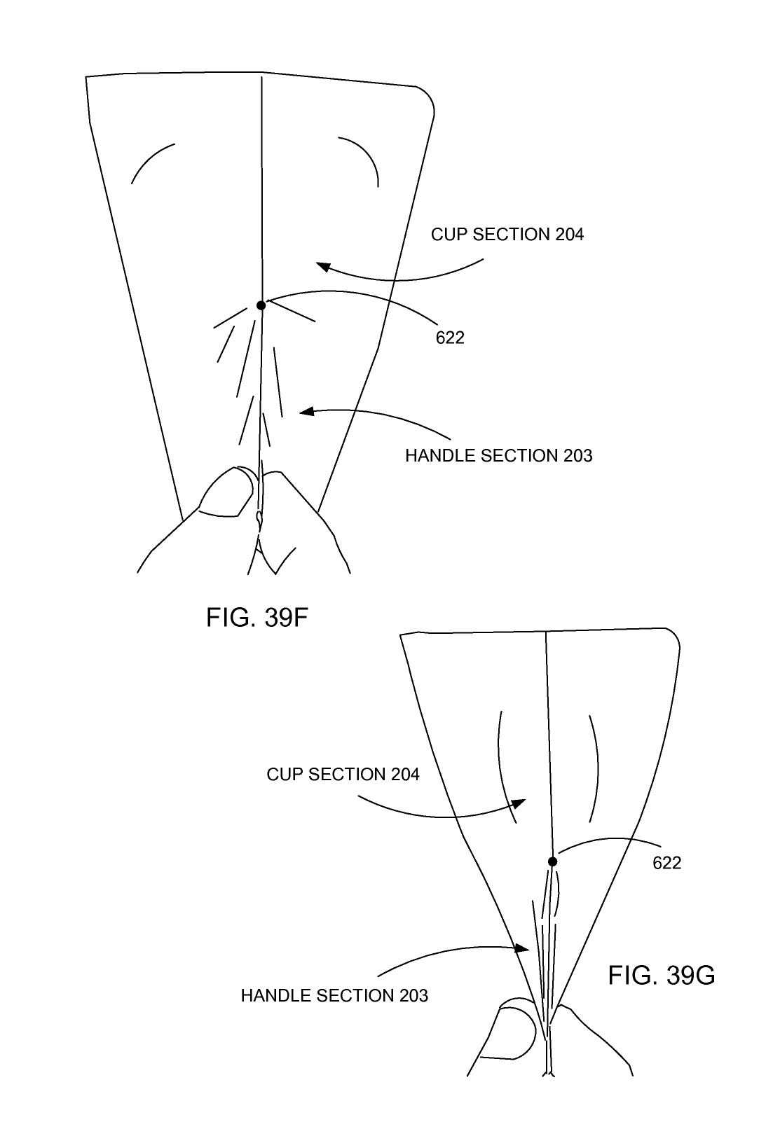

FIGS. 39-41 show another preferred embodiment of the present invention.

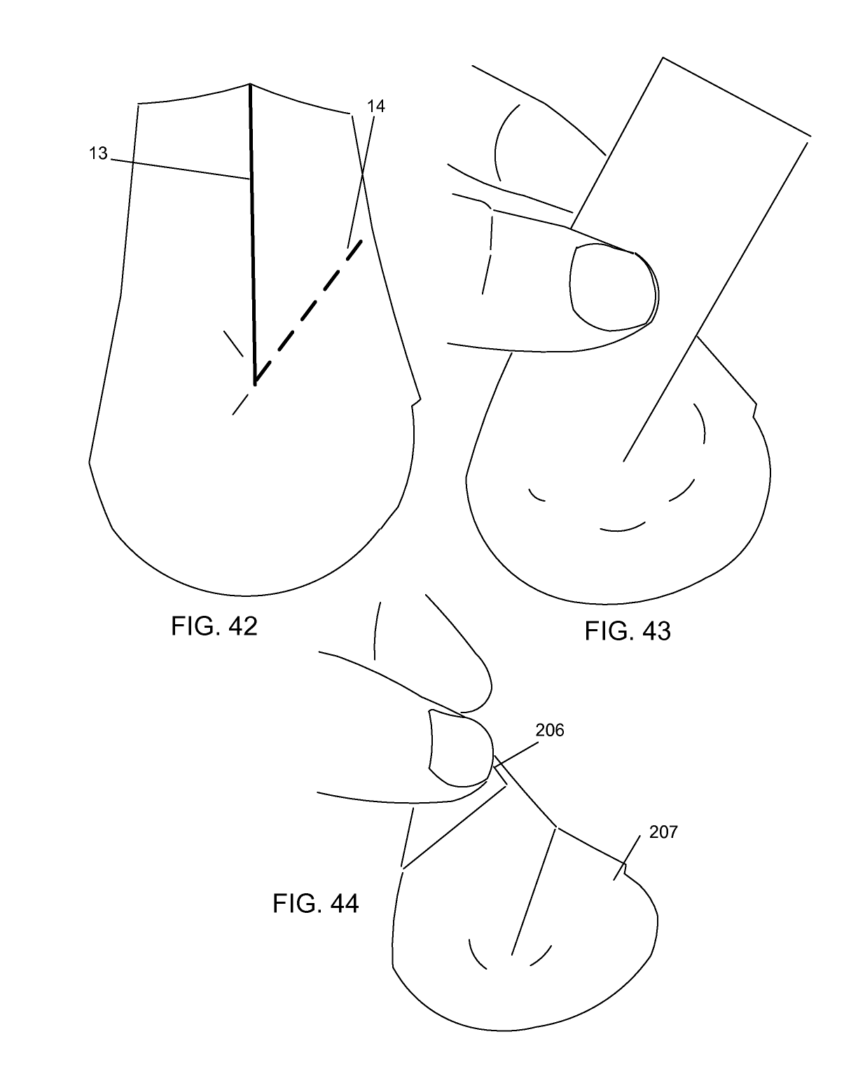

FIGS. 42-44 show another preferred embodiment of the present invention.

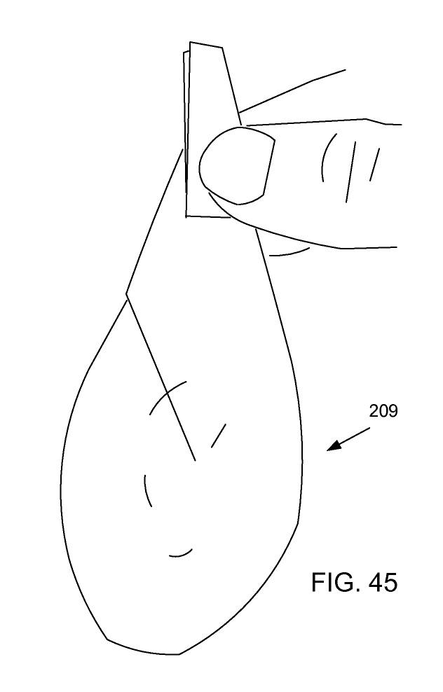

FIG. 45 shows another preferred embodiment of the present invention.

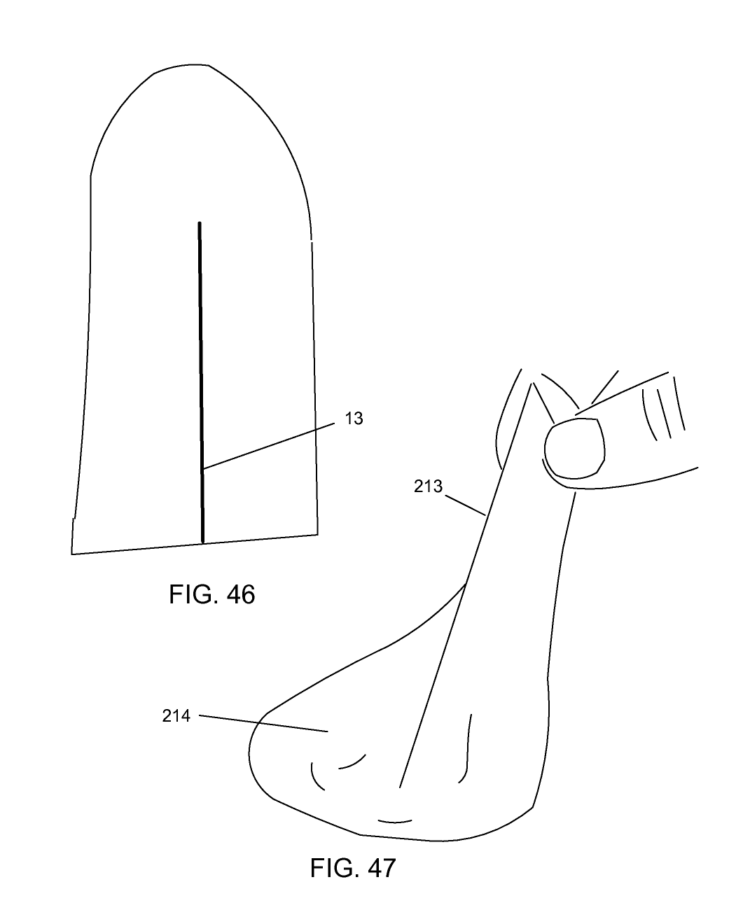

FIGS. 46-47 shows another preferred embodiment of the present invention.

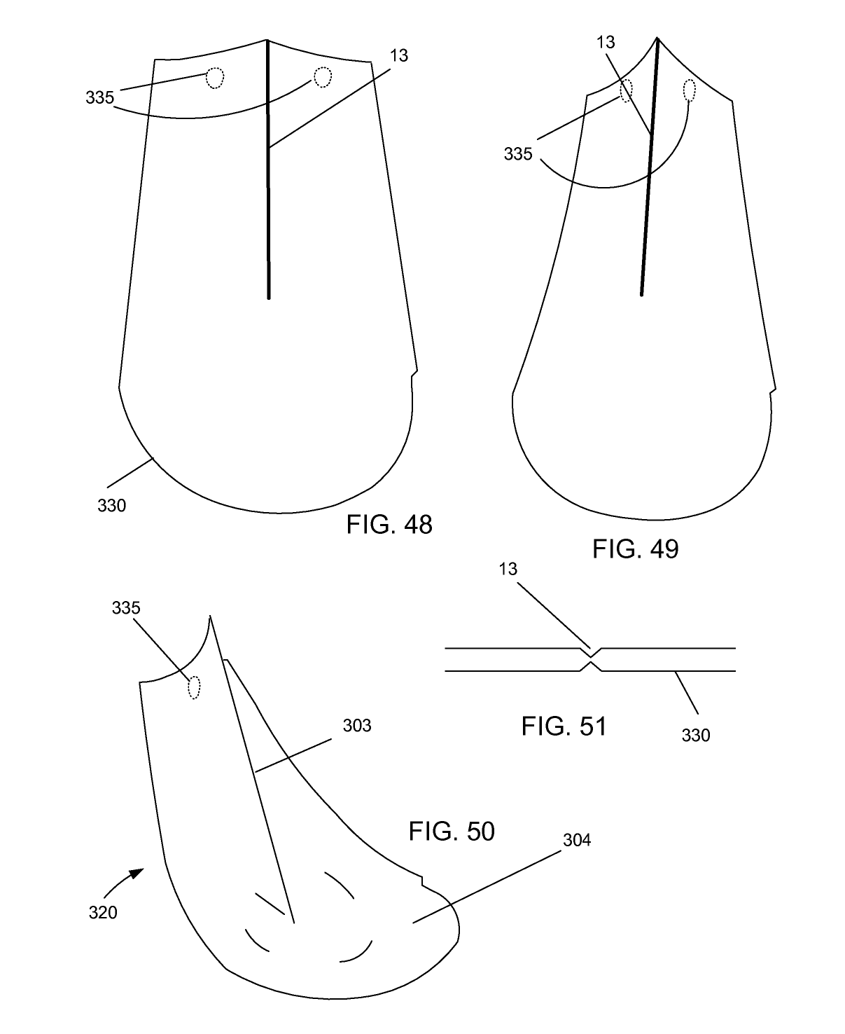

FIGS. 48-51 show another preferred embodiment of the present invention.

### DETAILED DESCRIPTION OF THE PREFERRED EMBODIMENTS

The present invention provides a folding spoon that can be economically packaged with a food product and then utilized for eating food.

### Preferred Methods for Folding

FIG. 1 shows sheet of paper 33. Paper 33 has been marked with solid lines 13 and dotted lines 14. Solid lines 13 represent apexes for folding outward and dotted lines 14 represent valleys for folding inward. Lines 13 and 14 are also shown in FIG. 7.

### Basic Fold

Prior to folding the paper, the user chooses where to place the apex of the fold. Preferably, apex 622 may be placed at any point along vertical line 620 that extends the full length of the sheet of paper and is halfway across the sheet of paper. For example, FIGS. 39A-39E show some of the alternate positions of apex 622.

An example of a basic fold is shown in FIGS. 39-41. Sheet 363 includes apex fold 13 that extends over half way down the sheet of paper. Apex 622 is positioned at the end of fold 13 approximately halfway down the sheet of paper.

In FIG. 40, the user has squeezed the upper end of the paper together at points 645 and 646. This has caused cup portion 204 to begin formation as shown.

In FIG. 41, the user has finished squeezing the upper portion of the paper and now has a handle so that he can hold the spoon. Cup portion 204 has been formed and is capable of holding a variety of material. For example, cup portion 204 can hold water, ice cream, cereal or soup.

FIGS. 39F and 39G show detailed views of the formation of cup portion 204 and handle section 203.

The following embodiments will show modifications and additions to the basic fold.

### Examples of Folded Utencils

FIGS. 8-10 illustrate the preferred method of folding. For demonstration purposes, the figures show that paper was utilized. However, other materials will work as well. For example, for eating thick, heavy, viscous foods (for example, thick ice cream) it is preferred to create the folding spoon from cardstock or paperboard.

FIGS. 8-10 show the basic folds utilized to create a preferred spoon. These folds can be modified as desired to create multiple variations of the basic design. As shown in FIG. 7, solid lines represent an apex and dotted lines represent valleys.

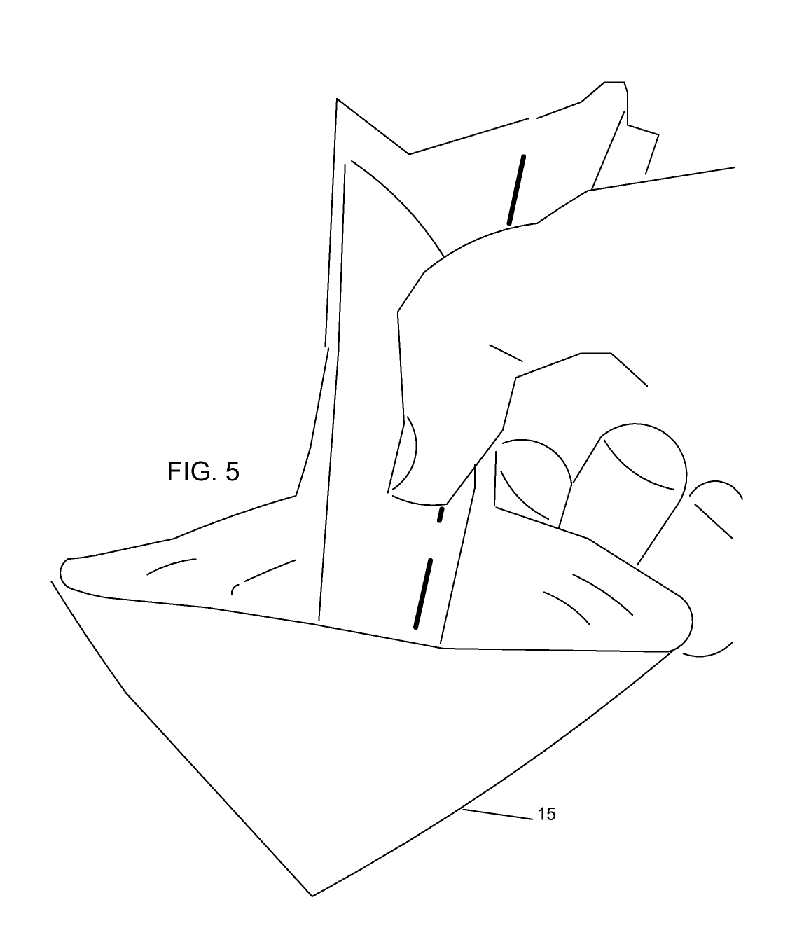

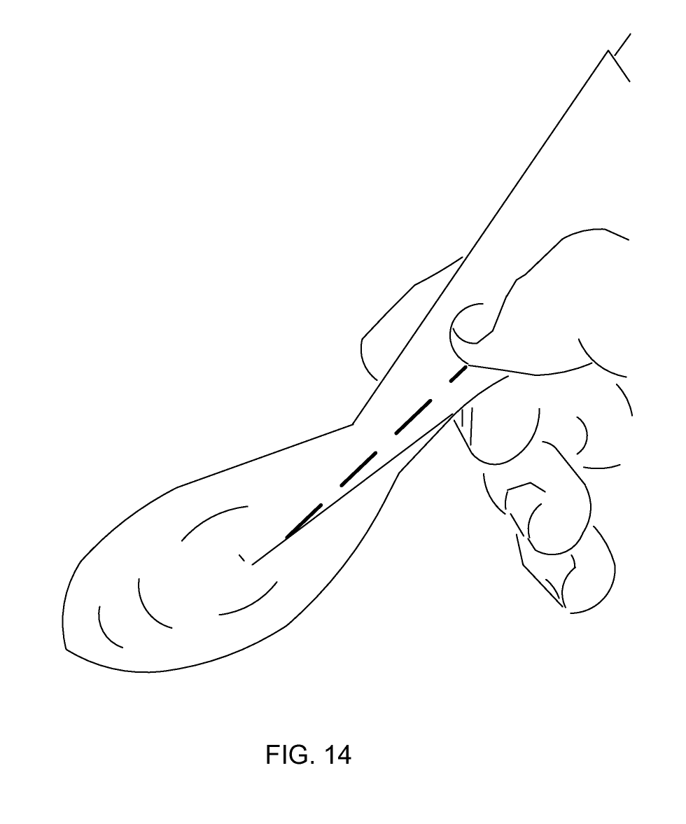

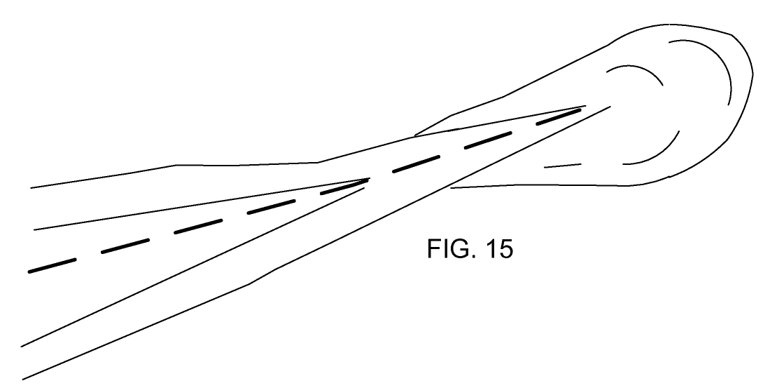

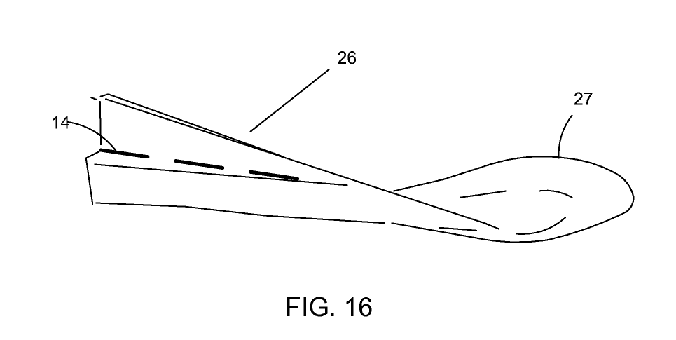

For example, FIGS. 1-6 show a first preferred embodiment of a folding spoon. From a single sheet of paper apex folds 13 and valley folds 14 are folded onto each other to create a strong, rigid handle 19 (FIG. 6). Cup portion 15 is used for scooping and holding the food. As shown in the figures, a user can create his spoon by following the steps clearly shown. FIGS. 11-18 show the steps for creating another preferred spoon having handle 26 and cup portion 27 (FIG. 16). Likewise, FIGS. 19-22 show the steps for creating yet another preferred spoon with handle 43 and cup portion 44

FIG. 23 shows folds 13 and 14 for a very simple spoon (FIG. 24) having handle 53 and cup portion 54. FIG. 25 shows folds 13 and 14 for another very simple spoon (FIG. 26) having handle 63 and cup portion 64. FIG. 27 shows folds 13 and 14 for a very simple spoon (FIG. 28) having handle 73 and cup portion 74. FIG. 29 shows folds 13 and 14 for another very simple spoon (FIGS. 30-31) having handle 83 and cup portion 84. FIG. 32 shows folds 13 and 14 for a very simple spoon (FIGS. 33-34) having handle 37 and cup portion 38. FIG. 33 shows the top view of the spoon. FIG. 33 shows the top view of the spoon. FIG. 34 shows the bottom view of the spoon. FIG. 34 shows the bottom view of the spoon. FIGS. 39 and 40 show fold 13 for a spoon (FIG. 41) having handle 203 and cup portion 204. FIG. 42 shows folds 13 and 14 for a spoon (FIGS. 43-44) having handle 206 and cup portion 207. FIG. 45 shows preferred spoon 209. FIG. 46 shows fold 13 for a spoon (FIG. 47) having handle 213 and cup portion 214.

### Preferred Usage Types

In a preferred embodiment of the present invention, a folding spoon is sold along with purchased food. In one preferred embodiment, the user purchases a single serving of ice cream a pint or half-pint container (FIGS. 35-38). Paper (i.e., cardboard, paperboard or cardstock) is included with the purchase. Preferably, the paper includes folds, creases, dotted lines, and solid lines to serve as a guide to the purchaser on how to fold a spoon. The purchaser is then able to easily fold the paper and create the spoon. In a preferred embodiment, instructions are also included as a guide to the purchaser.

For example, FIG. 35 shows an unfolded spoon 111 taped to the side of ice cream container 125. FIG. 36 shows unfolded spoon 141 press fit into the bottom of ice cream container 125.

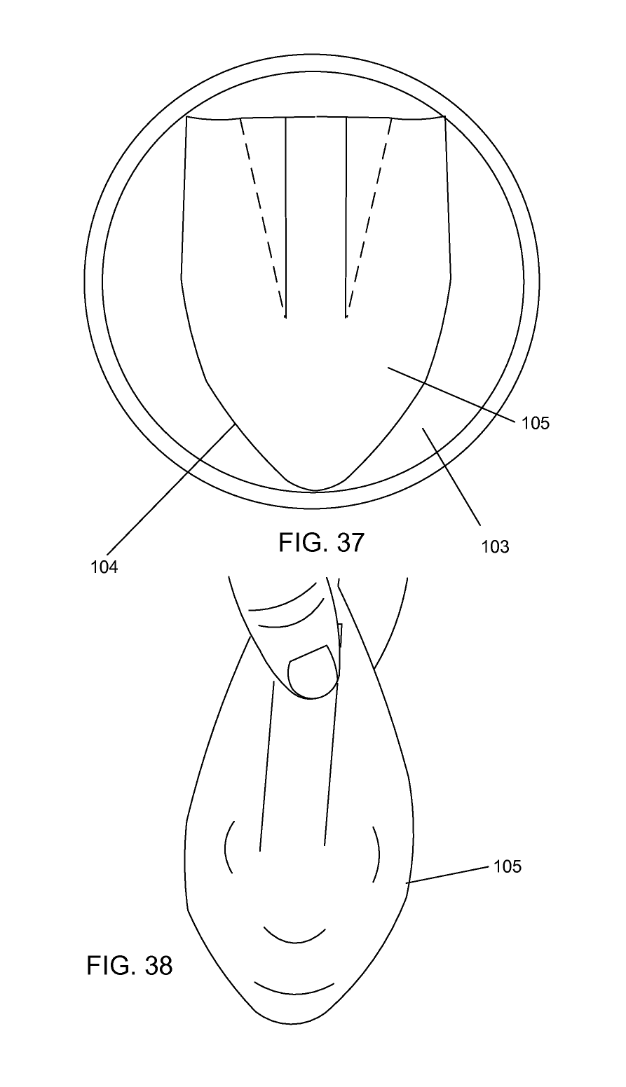

In another preferred embodiment, the single servicing ice cream container includes a lid 103 (FIG. 37). The lid preferably includes perforations, pre-folds, dotted lines, and solid lines to assist to consumer in creating his spoon. For example, outside edge 104 is perforated so that a purchaser of the ice cream container can easily punch out spoon 105 (unfolded) after removing lid 103 from the top of the ice cream container. The user can then easily fold the unfolded spoon to form folded spoon 105, as shown in FIG. 38.

### Other Materials

In other preferred embodiments it is possible to modify the material of the foldable spoon. For example, FIGS. 48-51 show a silicon sheet 330 that has been injection molded, as shown. As shown best in FIG. 51, sheet 330 is relatively thick to give it greater strength. The thickness decreases at fold 13 to make sheet 330 easier to fold. FIGS. 48-49 show sheet 330 in the process of being folded into a spatula. Sheet 330 includes binding devices 335. Binding devices 335 function to hold sheet 330 in place after it has been folded. In one preferred embodiment binding devices 335 are magnets. In other preferred embodiments, binding devices 335 are snaps. Likewise, binding mechanisms 335 can be a hook and loop fastener (i.e., VELCRO®), a plastic clip or even duct tape. In a preferred embodiment, binding devices 335 are embedded into sheet 330 during the injection molding process.

It is advantageous to use strong, heat resistant materials such as silicon to make bendable spoons as shown in FIGS. 48-51. The bendable spoon shown in FIGS. 48-51 can be used in high temperature situations, such as a spatula while frying food or as a soup spoon for cooking soup or chili.

Although the above-preferred embodiments have been described with specificity, persons skilled in this art will recognize that many changes to the specific embodiments disclosed above could be made without departing from the spirit of the invention. For example, in the above disclosure, examples were given of methods of folding spoons. It should be understood that the word “spoons” is understood to be used to refer to any object or utensil that is capable of scooping or moving a liquid or a solid, such as food or water. For example “spoons” is likewise understood to refer to such items as forks, knives, spatulas, scooping devices, shovels, snow shovels, hand shovels as well as many other similar devices. Also, the method of folding spoons described above can be applied to other utensils. For example, a variety of spoons, eating utensils, cooking utensils and scooping devices can be similarly created. Also, other materials can be utilized besides a sheet of paper. For example, sheets of plastic, sheets of metal and sheets of fiberglass can be utilized. It is even possible to fold types of food into spoons. For example, beef jerky can be easily folded into a spoon or spatula. Or a tortilla could be easily folded.

Furthermore, it should be understood that multiple sheets or sheets of various thicknesses could be utilized. For example, it would be possible to stack sheets (or laminate sheets) and then fold the sheets in utilizing the procedures described above. A stack of sheets and/or laminated sheets would add thickness and strength to the folded spoon. Other materials may also be utilized, such as injected silicone or molded rubber. Therefore, the attached claims and their legal equivalents should determine the scope of the invention

What is claimed is:

1. A foldable spoon formed from a sheet, comprising,
A) a spoon handle, comprising at least one apex fold, wherein said apex fold comprises an apex point that is positionable on a sheet of foldable material,
B) a spoon cup section connected to said spoon handle, wherein said sheet is bent backwards to form said spoon cup section, wherein said at least one apex fold and said spoon cup section are formed out of single sheet.

2. The foldable spoon as in claim 1, wherein said foldable spoon is sold with purchased food wherein said purchased food is purchased ice cream.

3. The foldable spoon as in claim 1, wherein said at least one apex fold is a plurality of apex folds, wherein said spoon handle further comprises a plurality of valley folds, wherein said plurality of apex folds and said plurality of valley folds and said spoon cup section are formed out of single sheet of paper.

4. The foldable spoon as in claim 1, wherein said single sheet of paper comprises:
A) folds,
B) creases,
C) dotted lines, and
D) and solid lines
wherein said folds, creases, dotted lines and solid lines provide guidelines for folding said foldable spoon.

5. The foldable spoon as in claim 1, wherein said single sheet of paper further comprises a set of instructions on how to fold said foldable spoon.

6. The foldable spoon as in claim 1, wherein said single sheet of paper is a single sheet of foldable plastic.

7. The foldable spoon as in claim 1, wherein said single sheet of paper is a single sheet of foldable metal.

8. The foldable spoon as in claim 1, wherein said single sheet of paper is a single sheet of foldable fiberglass.

9. The foldable spoon as in claim 1, wherein said single sheet of paper is a lid for an ice cream container, said lid comprising a perforated unfolded spoon, said unfolded spoon comprising:
A) folds,
B) creases,
C) dotted lines, and
D) and solid lines
wherein said folds, creases, dotted lines and solid lines provide guidelines for folding said foldable spoon.

10. The foldable spoon as in claim 1, wherein said folded spoon is fabricated from foldable silicon, wherein said foldable silicon comprises at least two embedded binding mechanisms.

11. The foldable spoon as in claim 10, wherein said embedded binding mechanisms are magnets.

12. The foldable spoon as in claim 10, wherein said embedded binding mechanisms are a hook and loop fastener.

13. The foldable spoon as in claim 10, wherein said embedded binding mechanisms are snaps.

14. The foldable spoon as in claim 1, wherein said sheet is a sheet of paper.

15. The foldable spoon as in claim 1, wherein said sheet is a stack of sheets.

16. The foldable spoon as in claim 1, wherein said sheet are laminated sheets.

17. The foldable spoon as in claim 1, wherein said sheet is fabricated from injected silicone.

18. The foldable spoon as in claim 1, wherein said sheet is fabricated from molded rubber.

19. A method for forming a foldable spoon formed from a sheet, comprising the steps of:
A) selecting an apex point, wherein said apex point is positionable on a sheet of foldable material,
B) squeezing said sheet to form an apex fold that starts at said apex point and extends to the edge of said sheet and to form a spoon cup section, wherein said apex fold is a spoon handle and wherein said spoon cup section is connected to said spoon handle,
wherein said at least one apex fold and said spoon cup section are formed out of single sheet of paper.
